(19) United States
(12) Patent Application Publication
(10) Pub. No.: US 2006/0143087 A1
(43) Pub. Date: Jun. 29, 2006

(54) Restaurant management using network with customer-operated computing devices

(76) Inventors: Travis Scott Tripp, Fort Collins, CO (US); Mark Kendall Vaszary, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/024,105

(22) Filed: Dec. 28, 2004

(51) Int. Cl. G06F 17/60

(52) U.S. Cl. 705/15

(57) ABSTRACT

The present invention provides restaurant management method in which a customer operates a computing device to make requests. A waiter can fulfill the request on the next visit to the customer's table, instead of having to visit the table first to obtain the request and requiring a second visit to fulfill the request.

### BACKGROUND OF THE INVENTION

The present invention relates to restaurant management and, more particularly, to restaurant management using computers to help automate service. The present invention provides for more efficient and effective service to restaurant customers. Below, related art is presented to help explain the invention. Related art labeled “prior art” is admitted prior art, while related art not labeled “prior art” is not admitted prior art.

Restaurants compete with each other not only in terms of food selection and quality, and price, but also in terms of quality of service. Long delays waiting for an initial order to be taken, waiting for the items ordered to be presented, and for the bill to be presented can detract from an otherwise positive culinary experience. However, as all three of the dining milestones can be expected for every meal, restaurant staff are typically well attuned to them. However, many restaurants are less effective at addressing customer needs that are not universal: taking orders after the initial orders, providing refills on a timely basis, and meeting special needs in equipment, foods, and billing.

Typically, waited-table service staff must constantly check-in with the customers and customers must wait until the service staff comes by to request service or to order. Often a customer must struggle to obtain the attention of restaurant staff, who may be attending to other customers. Once the attention is obtained and the request made, the staff person must also leave to obtain any item necessary to meet the request. In the meantime, the staff person can be interrupted by requests from other customers. As a result, fulfillment can be delayed; in some cases, requests may be forgotten due to interruptions.

### SUMMARY OF THE INVENTION

This invention provides for a restaurant-management method and an associated network and software in which customers make requests using customer-operated devices that communicate with staff operated devices. The requests can be of a form that would require a staff person to bring an item to a customer so that the item can be brought the next time a staff person attends to the customer.

The invention relieves customers of the task of trying to capture a staff person's attention and relieves the staff person of the need to go to a table to find out the nature of a customer's request. Instead, the request can be ascertained from the staff's device and met the next time the staff visits the customer's table. The customer's request can be met more expeditiously and staff can get more accomplished. In addition, the duration between request and fulfillment can be tracked as a staff performance measure; upon excessive delays, other staff can be alerted and rewarded for fulfilling the request. Furthermore, the devices are readily configurable to provide additional advantages as is apparent from the description below with reference to the following drawings.

### BRIEF DESCRIPTION OF THE DRAWINGS

The following figures are embodiment-specific and are not representative of the full scope of the invention.

FIG. 1 is a schematic illustration of a restaurant management system in accordance with the present invention.

FIG. 2 is a flow chart of a first part of a restaurant-management method employed in the system of FIG. 1 and in accordance with the present invention.

FIG. 3 is a flow chart of a second part of the restaurant management method of FIG. 2.

FIG. 4 is a flow chart of a third part of the restaurant-management method of FIG. 3.

### DETAILED DESCRIPTION

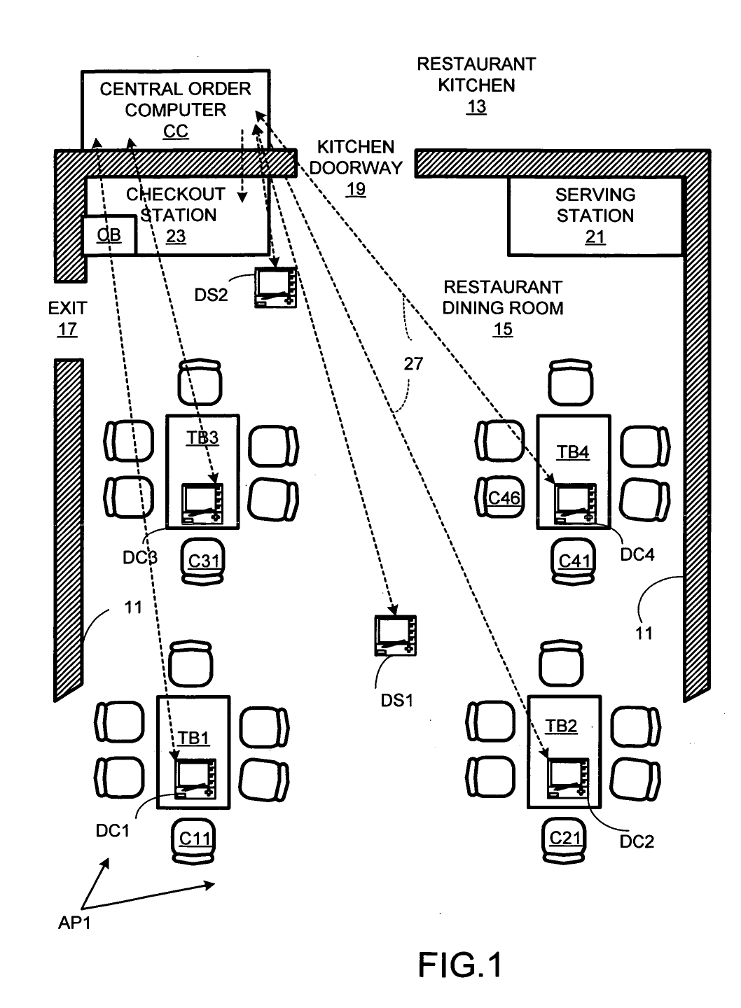

In accordance with the present invention, a restaurant AP1 is shown in FIG. 1 in which customer-operated computing devices facilitate and improve a waited-table restaurant experience. The illustrated restaurant has walls 11 defining a kitchen 13, a dining room 15, an entrance/exit 17, and a kitchen doorway 19. Dining room 15 includes dining tables, including tables TB1-TB4, a serving station 21, and a checkout station 23. Several chairs, e.g., chairs, C11-C46 are provided at each table. This specific layout is only one of a great many waited-table restaurant layouts to which the invention can be applied.

In restaurant AP1, waiters and other service staff carry staff computing devices, e.g., DS1 and DS2 that can be used to take orders and communicate them wirelessly over a network 27 to a central-order computer CC, which in turn, can provide billing information to a billing computer CB located at checkout station 23. In addition, customer computing devices are provided for customers in accordance with the invention. In the illustrated embodiment, the customer devices DC1-DC4 can perform a subset of the functions performed by staff devices DS1, DS2.

The various computing devices can be personal digital assistants (PDAs), such as iPaqs available from Hewlett-Packard Company, that run restaurant-management software and communicate with each other and computers CC and CB using a IEEE 802.11g wireless standard. Alternatively, other types of devices and communication methods can be used. In the illustrated embodiment, the staff and customer devices are provided by the restaurant. Alternatively, the invention provides for optionally programming certain customer-owned devices, e.g., PDA's or smart cell phone, to function as customer interfaces to restaurant computing network 27.

Customer devices DC1-DC4 are located at respective tables TB1-TB4. In the illustrated example, the customer devices are provided to customers as they are seated. Typically, one device is provided for each table at which one customer or one group of customers is seated. Also, the devices may be integrated into or attached to respective tables, chairs, or chair armrests.

Each customer device DC1-DC4 has knowledge of the table number and location, of the restaurant menu including supplementary free items (salt, ketchup), of ingredients and health information for each item on the menu. Each device can accept orders, keeping track of which customer (e.g., as associated with seat positions) ordered what, and adding up nutritional and caloric content for each customer. In addition, a running total of charges can be calculated as items are selected and an order is assembled; the running total can take into account taxes and tips. Optionally, a customer can set a “budget threshold”, and the customer device can provide a warning as the threshold is crossed.

Regarding billing, devices DC1-DC4 permit customers to select among billing options. For example, split bills can be set up either in terms of percentages or currency (e.g., dollar) amounts; alternatively, bills can be split so that each person pays for the cost of that person's meal. The device can recommend tips according to whether a meal is personal or for business, according to the number of requests handled by restaurant staff, and according to an indicated level of customer satisfaction. Different tip levels can be selected by different customers at the same table. Charges can be reviewed on the device. Once a customer is ready to pay, the device can be used to notify staff. For tabs setup with a credit card, the charge can be viewed and signed, using an available stylus, right on the device. A paper copy can be picked up at the checkout counter. Alternatively, a customer can enter an email address to which the bill can be emailed for reimbursement or record-keeping purposes.

Staff devices DS1 and DS2 largely replicate the functionality of the customer devices so that a waiter can enter orders and requests when customers prefer. In addition, staff devices have an overview of the restaurant so that each staff can see what is going on at all tables. For example, each staff device indicates requests from tables, including those assigned to other staff, that are not fulfilled within a time prescribed by management, e.g., three minutes maximum for condiments, five minutes maximum for processing a bill. If a maximum time limit is exceeded, a staff person not assigned to the table can fulfill the request; by way of incentive, the intervening staff can receive a percentage of the tip for the table. This system provides an incentive for service staff to stay on top of their own tables so they do not risk having to share their tips.

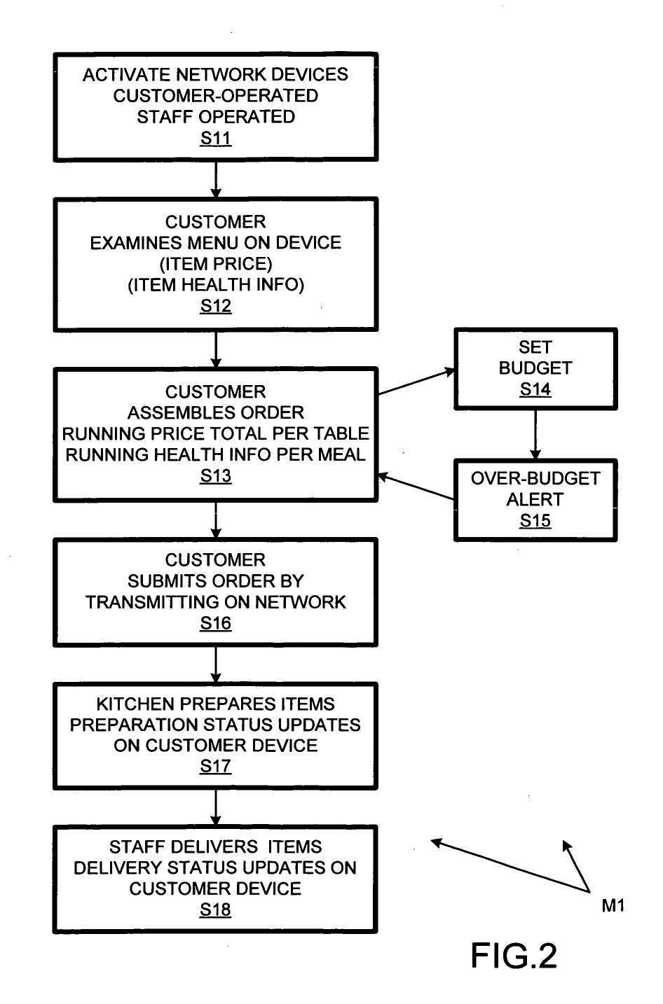

A method M1 practiced in the context of restaurant AP1 is flow charted in FIGS. 2-4. Method M1 can begin with activating the customer and staff devices at a step S11 as shown in FIG. 2. The staff devices can be activated as the staff begins work, while customer devices can be activated as customers are seated.

Alternatively, customers can use their own devices or restaurant devices prior to seating (e.g., where a table is not immediately available or while waiting for guests to arrive) to pre-order meals. The pre-ordering can be done within the restaurant, e.g., in a lounge area, in the vicinity of the restaurant, e.g., via a wireless network that extends beyond the confines of the restaurant, or even remotely, e.g., via the Internet. Pre-ordered meal can be “queued” so that they can be prepared immediately after the customers are seated.

Customers can examine menu items at step S12 on the display of the provided customer device, which can be used in conjunction with traditional menus. An opening page allows customers the options of requesting a waiter to take an order, exploring available items, and placing orders electronically. Selecting exploring brings up lists of food items by category in this example. For each item, a customer can order it or request more information. If more information is requested, a detailed description of the item is presented along with selections for a picture of the item, item ingredients, and nutritional information. Note that a larger display can be used to present more information at once. At any page providing information about an item, the customer can order the item.

When an item is selected as part of the order being assembled at step S13, an image of the table is provided. A customer can select quantities and sizes for items and can assign a seat for each item ordered; alternatively, the customer can select the table itself for shared items, e.g., appetizers. Running totals for price are maintained for the table, while nutritional values are accumulated on a per patron (per seat) basis. Optionally, a customer can set a budget threshold at step S14, in which case the customer device issues an alert at step S15 if and when the total price for the order exceeds the threshold.

When the order is complete, it can be submitted at step S16 automatically by the customer via the customer device to central order computer CC, which forwards the order to the staff device of the staff person attending the table. At any stage of the ordering processing, a customer can summon a staff person to assist in assembling or placing the order by issuing a request for order assistance via the customer device.

Central-order computer CC displays the order to kitchen staff who prepare the ordered items at step S17 and notify service staff when the items are ready. The service staff can then bring them to the customers. The customers or staff can indicate when an ordered item is delivered on a respective device. In an alternative restaurant, prepared items are placed on a counter and the customers signaled to come get them. In either case, the computer CC can inform customers via customer devices DC1-DC4 regarding order status, including which items have or have not been delivered at step S18. While the devices can give customers the ability to summon staff at any time, it should be noted that the automatic ordering frees the customer and staff from the delay involved in having the staff return to the table to take the order. Instead, the next visit to the table by the staff involves bringing some or all of the ordered items.

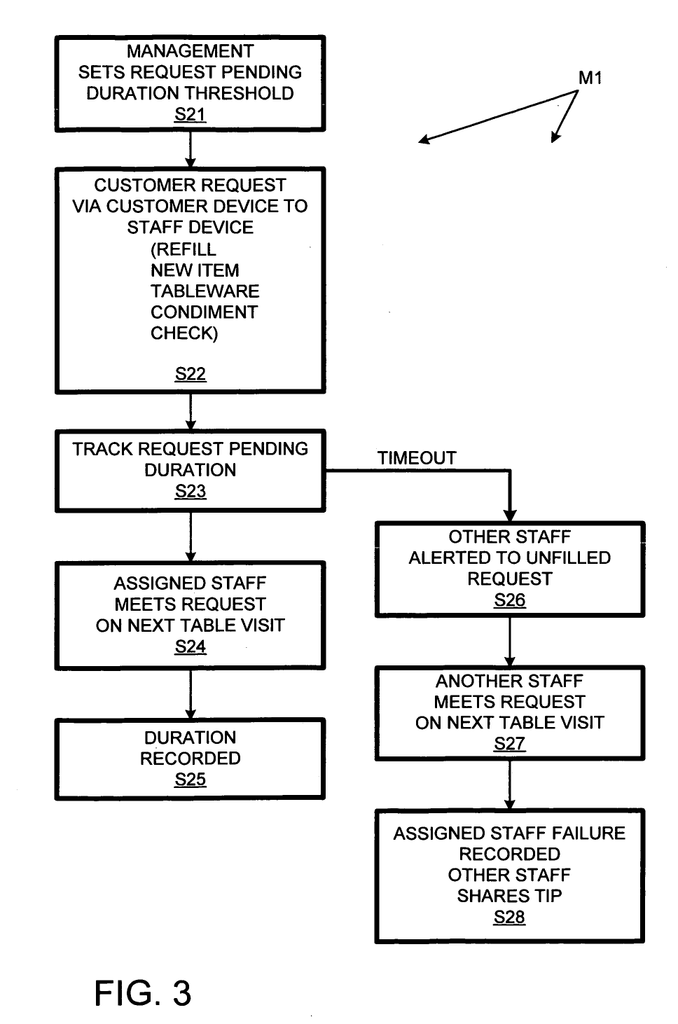

Once the order has been placed and served, the customer device provides further options at step S22, FIG. 3, to order free refills of ordered items permitting free refills, additional items (e.g., dessert), free items (e.g., water, coffee, bread, butter, salt, pepper, catsup), dining ware (knives, forks, spoons, plates, cups, etc), etc. In addition, a customer can order clean up, e.g., of spills or of empty plates and cups. These requests are wirelessly communicated to central-order computer and forwarded to staff.

At step S21, which is executed prior to step S22, restaurant management can program central-order computer CC with duration thresholds within which respective request types are to be fulfilled. When a request is made, the request is time stamped by central-order computer CC and the duration of an unfilled request is tracked at step S23. Typically, the staff person assigned to the requesting table can fulfill a request within the duration threshold on the next visit to the table at step S24. When a request is fulfilled, the customer or staff person can so indicate. The duration lapsed between request and fulfillment is recorded by computer CC at step S25, and the fulfillment durations for a staff person can be used as a performance measure.

If a fulfillment threshold passes without the request being fulfilled by the assigned staff person, central order computer CC alerts other staff persons via their staff devices of the table and the request at step S26. Staff persons not assigned to the requesting table can then fulfill the request at step S27. The failure of the assigned staff person to fulfill the request in a timely manner is recorded at step S28. The staff person who fulfilled the request shares in the tip left for the table by the requesting customer as a reward. In addition, the system allows a staff member to acknowledge that they have started to fulfill a request. This is done so that the same request is not handled in parallel by multiple staff members.

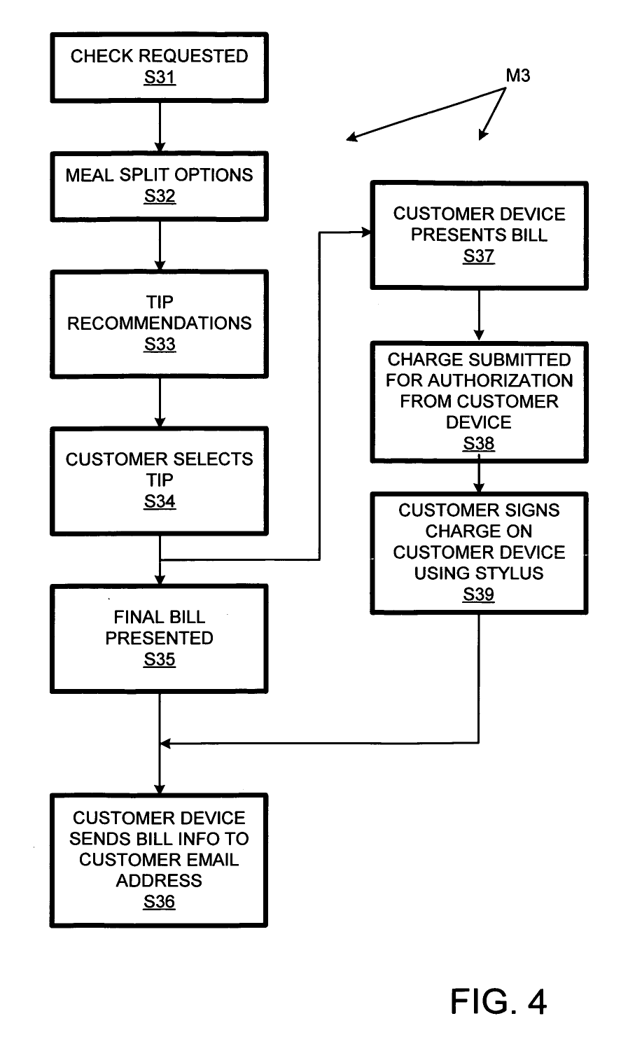

When a customer is ready to check out, the customer device can be used to request “the check” at step S31, FIG. 4. Central-order computer CC can acknowledge the request and provide the price. The customer can be given the option of splitting the bill among tablemates, e.g., the bill can be split evenly or in proportion to respective meal prices. In addition, the customer can be presented at step S33 with tip options, e.g., as a function of the number of requests made by customer and fulfillment durations, customer satisfaction level(s), and whether the meal is a business or personal meal. The customer selects a tip at step S34, and a final bill can be presented by a staff person at step S35. The customer device can then send bill information to an email address specified by the customer for bookkeeping purposes at step S36.

Alternatively, the final bill can be presented on the customer device at step S37. If the meal is to be charged to a credit card, the charge can be submitted for authorization from the customer device via central-order computer CC to the authorizing bank at step S38. If the charge is authorized, the customer can sign the charge slip digitally on the customer device using a provided stylus at step S39. Then the bill can be sent to customer's email address at step S36. The final bill can also be split amongst two or more patrons at the same table, such that each patron can get an electronic receipt on their personal devices or an individual hard copy print of the receipt.

The invention allows customers to make more informed choices regarding menu items and their costs. Customers can communicate their requests immediately, rather than having to wait until they can attract the attention of a restaurant staff person. In addition, staff are made aware customer requests promptly without having to constantly monitor tables for manual customer signals. Staff productivity is enhanced as fewer trips to a table are required to meet customer requests. Management can be more effective, customer devices can allow immediate feedback as to satisfaction (e.g., as tips are selected or separately) and as staff performance is automatically tracked by the staff devices. More flexible and convenient billing options, including tip recommendations, are provided. In general, the invention provides for greater customer satisfaction and greater staff productivity.

The present invention provides for restaurants of different sizes, styles, and cuisine. Whatever the type of restaurant, the customer can avoid waiting for restaurant staff to acknowledge hand signals, waiting for the staff to come to the table to receive a request, and then waiting for the staff to fulfill the request. These and other modifications to and variations upon the described embodiments are provided for by the present invention, the scope of which is defined by the following claims.

What is claimed is:

1. A restaurant management method comprising:
a customer communicating a request to at least a first staff person of a restaurant by operating a customer computing device that communicates at least partially wirelessly with a first staff computing device operated by said first staff person, said request requiring a staff person of said restaurant to bring some thing to a location at of said customer, said customer computing device and said first staff computing device belonging to a restaurant computing network;
said first staff person or another staff person of said restaurant obtaining said thing without first approaching said location; and
said first staff person or another staff person fulfilling said 3 request the next time that staff person approaches and attends to said location.

2. A method as recited in claim 1 wherein:
said request is not fulfilled within a predetermined duration after said request is communicated;
a second staff person of said restaurant is alerted by said network via a second staff computing device of said network that said request has not been timely fulfilled;
said thing being obtained by said second staff person
said fulfilling being effected by said second staff person.

3. A method as recited in claim 2 wherein the failure of said first staff person to fulfill said request is recorded by said network.

4. A method as recited in claim 2 wherein said network determines how a tip left by said customer is to be divided between said first and second staff persons.

5. A method as recited in claim 2 further comprising a step of, before said customer communicates said request, restaurant management communicating said predetermined duration to said network.

6. A method as recited in claim 1 wherein said request is for a refill of a previously ordered and served item.

7. A method as recited in claim 1 wherein said customer obtains quantitative health information for selected menu items via said first computer device.

8. A method as recited in claim 1 wherein said customer obtains cumulative quantitative health information for meals including two or more menu items.

9. A method as recited in claim 1 wherein said customer obtains total price information for an order including plural menu items via said first computing device before said order is submitted for fulfillment.

10. A method as recited in claim 9 wherein said total price information includes projected tips.

11. A method as recited in claim 1 wherein said device provides recommendations for tips and said customer selects one of said recommendations.

12. A method as recited in claim 5 wherein said customer indicates a maximum cost and said device alerts said customer when said maximum cost is exceeded by an order before it is submitted.

13. A method as recited in claim 5 wherein said customer specifies a bill-splitting scheme via said device.

14. A method as recited in claim 8 wherein said schemes include splitting a bill evenly among customers and splitting a bill as a function of meals ordered by each customer.

15. A method as recited in claim 1 wherein said customer orders a meal prior to customer's arrival at said location using said customer computing device, said meal being served to said customer after said customer arrives at said location.

16. A method as recited in claim 15 wherein other customers order meals using other customer-operated devices, said meal being served to said customer and said other customers after they meet at said location.

17. Computer readable media comprising restaurant-management software including:
customer-operated software allowing a customer to select a request, fulfillment of which requires some thing being brought to said customer;
staff operated software for presenting said request to a first staff person so that said staff person can obtain said thing without first approaching said customer is located and so that said request can be fulfilled the next time said first staff person approaches said customer; and
communications software for permitting said request to be communicated from said customer-operated software to said staff-operated software.

18. Media as recited in claim 17 wherein, if said first staff person fails to fulfill said request within a predetermined duration after said request is made, said staff-operated software presents said request to a second staff person.

19. Media as recited in claim 17 wherein, if said first staff person fails to fulfill said request within a predertermined duration after said reuest is made, said restaurant-management software records a failure and associates it with said first staff person.

20. Media as recited in claim 18 wherein said restaurant-management software determines how a tip left by said customer is to be divided between said first and second staff persons.

21. Media as recited in claim 17 wherein said request is for a refill of a previously ordered and served item.

22. Media as recited in claim 17 wherein said customer-operated software provides obtains quantitative health information for selected menu items via said first computer device.

23. Media as recited in claim 22 wherein said customer-operated software provides cumulative quantitative health information for meals including two or more menu items.

24. Media as recited in claim 17 wherein said customer-operated software provides total price information for an order including plural menu items before said order is submitted for fulfillment.

25. Media as recited in claim 24 wherein said total price information includes projected tips.

26. Media as recited in claim 17 wherein said customer-operated software provides recommendations for tips and records a selected one of said recommendations.

27. Media as recited in claim 17 wherein said customer-operated software records a maximum cost indicated by said customer and alerts said customer when said maximum cost is exceeded by an order before it is submitted.

28. Media as recited in claim 17 wherein said customer-operated software presents to said customer bill-splitting scheme and provides for recording a customer selection of a bill-splitting scheme.

28. Media as recited in claim 28 wherein said schemes include splitting a bill evenly among customers and splitting a bill as a function of meals ordered by each customer.

29. A restaurant management network comprising:
a customer device for accepting requests from a customer, said request requiring a staff person of said restaurant to bring some thing to said customer;
a first staff-operated device for receiving said request so that a first staff person can obtain said thing without first approaching said customer and so that said first staff person can provide said thing to said customer the next time said first staff person approaches and attends to said table.

30. A network as recited in claim 29 further comprising a second staff-operated device for, in the event said first staff fails to fulfill said request within a predetermination duration after said request, informing a second staff person of said request.

31. A network as recited in claim 30 wherein the failure of said first staff person to fulfill said request is recorded by said network.

32. A network as recited in claim 30 further comprising means for determining how a tip left by said customer is to be divided between said first and second staff persons.

33. A network as recited in claim 29 wherein said request is for a refill of a previously ordered and served item.

34. A network as recited in claim 29 wherein said customer device provides quantitative health information for selected menu items via said first computer device.

35. A network as recited in claim 29 wherein said customer device provides obtains cumulative quantitative health information for meals including two or more menu items.

36. A network as recited in claim 29 wherein said customer device provides total price information for an order including plural menu items via said first computing device before said order is submitted for fulfillment.

37. A method as recited in claim 36 wherein said total price information includes projected tips.

38. A network as recited in claim 29 wherein said customer device provides recommendations for tips and said customer selects one of said recommendations.

39. A network as recited in claim 33 wherein said customer device indicates a maximum cost and said customer device alerts said customer when said maximum cost is exceeded by an order before it is submitted.

40. A network as recited in claim 33 wherein said customer device alows said customer to specify a bill-splitting scheme via said device.

41. A network as recited in claim 33 wherein said device provides for splitting a bill evenly among customers and splitting a bill as a function of meals ordered by each customer.
